(19) United States
(12) Patent Application Publication
(10) Pub. No.: US 2010/0095489 A1
(43) Pub. Date: Apr. 22, 2010

(54) METHOD FOR THE PRODUCTION OF AN ADHESIVE CLOSURE DEVICE TOGETHER WITH APPARATUS AND ADHESIVE CLOSURE DEVICE PRODUCED ACCORDINGLY

(76) Inventor: Jan Tuma, Herrenberg (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/449,843

(22) PCT Filed: Jan. 29, 2008
(86) PCT No.: PCT/EP2008/000646

§ 371 Date: Aug. 31, 2009

(30) Foreign Application Priority Data
Mar. 30, 2007 (DE) 10 2007 015 441.2

(51) Int. Cl. A44B 18/00; B32B 37/15; B29C 47/06

(52) U.S. Cl. 24/442; 156/298; 156/500

(57) ABSTRACT

Method for the production of an adhesive closure device together with an apparatus and adhesive closure device produced accordingly. The invention relates to a method for the production of an adhesive closure device (10), preferably consisting of at least one plastic material, during which a backing (12) with a plurality of protruding stems (14) is connected to individual heads (16) in such a way that for at least a part of the above-mentioned stems (14), the free ends (18) thereof come into contiguous or embedded contact with a contact face (20) of each assignable head (16). The invention relates additionally to an apparatus for carrying out the method and to an adhesive closure device produced according to the method.

The invention relates to a method for the production of an adhesive closure device, preferably consisting of at least one plastic material. The invention relates furthermore to an apparatus for carrying out the method and an adhesive closure device produced according to the method and using the apparatus according to the invention.

These touch fastener elements, which also include mechanical fastening elements, with touch fastener elements made in a complementary manner, form a fastener which can be repeatedly opened and closed, hooks or mushroom-like fastener parts interacting with loop-like fastener elements of another touch fastener element with the formation of a touch fastener. Solutions are also known in which the same touch fastener elements of two different touch fastener elements interact with one another (hermaphroditic fastener).

Thus DE 699 22 264 T2 discloses supplying a belt-like backing part with a plurality of projecting stem parts to a molding gap between heatable molding rolls, into which by way of an extrusion means an additional molding belt of plastic material can be supplied which as the actual molding tool with mold recesses shapes the hot stem ends of the stem parts into head parts in order to obtain a mushroom-like touch fastener element in this way. Since the indicated head parts in the known solution are formed from the plastic material of the stem parts, in this respect the head parts are of smaller dimension due to low material charging in the free and therefore projecting head surface which is available for interlocking; this can adversely affect the required adhesion forces.

Conversely, U.S. Pat. No. 6,180,205 B1 proposes a production method using a molding roll in which a belt-like backing part can be connected to a plurality of hook fastener elements which can be dimensioned to be relatively large. For this purpose the molding roll on its outer periphery has hook-shaped mold recesses into which plastic material is pressed to fill the mold by way of a first extruder means. Excess plastic material on the outer peripheral side of the molding roll is removed by means of a cutting removal means which is technically called a doctor blade. By means of a second extruder means which is located downstream in the production direction, the backing part material is then applied and permanently connected to the hook-shaped fastener parts during the cooling process of the roll. A stripper roll then removes the finished fastener part from the molding means. Due to the hook geometry, difficulties can arise during the mold removal process and, furthermore, a relatively high proportion of plastic scrap is formed in the production process due to use of the indicated doctor blade.

WO 2006/099000 A2 furthermore discloses spraying a belt-like conveyor device on its upper strand side with droplets of plastic material, the plastic material being molded based on its surface tension into hemispherical shell bodies which are then permanently connected on their arching top to a belt-like backing part, with the formation of a touch fastener element. In one development of this solution it is also possible, in the manner of thickened stem parts, to supply a belt-like backing part which on its top bears grain-shaped agglomerates as the stern parts onto which then the hemispherical head parts can be placed. The touch fastener element which is produced in this way and which is designed to be used in particular as a fastener for baby diapers or incontinence diapers is, however, made relatively stiff and leaves much to be desired with respect to the fastener characteristics. US 2006/0220271 A1 discloses a comparable solution which, however, calls for a molding tool in the form of a molding roll with the corresponding mold recesses instead of a belt for production of hemispherical fastener elements. In this respect production of stem parts between the head parts and backing part is not done with this known solution.

U.S. Pat. No. 5,785,784 discloses a production method for producing a belt-like backing part on which there are a plurality of projecting stem parts. In a downstream production step the free stem ends are heated and then thicken as a result of the surface tension of the plastic material, in particular, into a hemispherical head part. If, in a continuation of the known solution, the head parts produced in this way are reshaped by means of a so-called calander rolling method, widened head part geometries are formed which with respect to the low material charge are made relatively small and are widened only in the direction of the earlier rolling direction.

Based on this prior art, the object of the invention is to further improve the known solutions while retaining their advantages, especially at low production costs to devise a reliable touch fastener which can be adjusted in wide ranges in terms of its fastening behavior. This object is achieved by a method with the features of claim 1; an apparatus with the features of claim 3 and a touch fastener element with the features of claim 6.

The method according to the invention is used to produce a touch fastener element, preferably consisting of at least one plastic material which is characterized in that a backing part with a plurality of projecting stem parts is connected to individual head parts such that at least for some of the indicated stem parts their free ends come into contiguous or embedded contact with the contact side of the respectively assignable head part. By subsequently placing separately produced head parts on the free end side of the assignable stem parts different material components of the stem parts can be combined with head parts in very wide ranges and likewise different geometries for head parts and/or stem parts can be defined. Based on the plurality of combination possibilities, a plurality of technical parameters can thus be set in a touch fastener element produced in this way. The method according to the invention is moreover reliable in application and can be economically implemented.

An apparatus has proven to be especially economical for carrying out the method in which for the individual head parts there is a molding tool with a plurality of mold recesses which correspond to the respective head geometry, and with a supply device for the already finished backing part with the stem parts whose free ends can be inserted into the mold recesses by means of the supply device.

The touch fastener element is especially serviceable and mechanically durable if the stem parts and head parts consist of plastic materials which are different from one another, in particular the stem parts are formed from a thermoplastic and the head parts consist of acrylate material. The relatively hard acrylate material for the respective head part allows the possibility of resistant hooking underneath for the loops of a corresponding touch fastener element so that a touch fastener structured in this way enables very high adhesive and peeling strength values.

Other advantageous embodiments of the solution according to the invention are the subject matter of the other dependent claims.

The solution according to the invention is detailed below using one exemplary embodiment as shown in the drawings. The figures are schematic and not to scale.

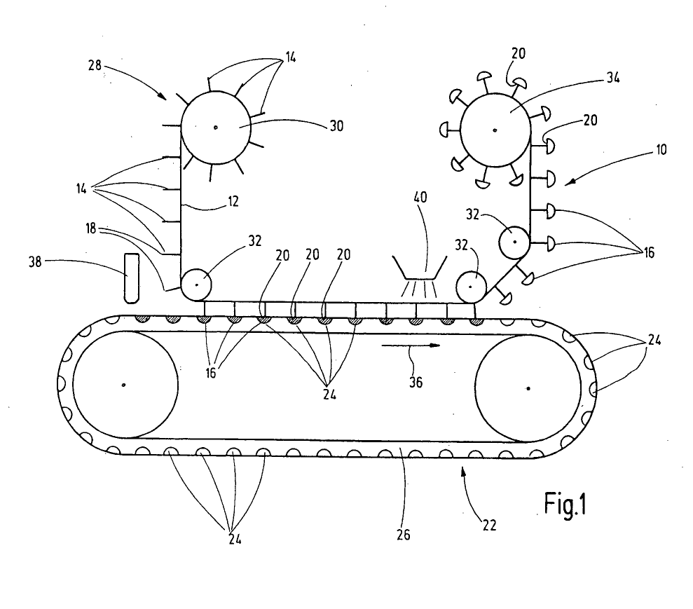

FIG. 1 shows a part of the production apparatus according to the invention;

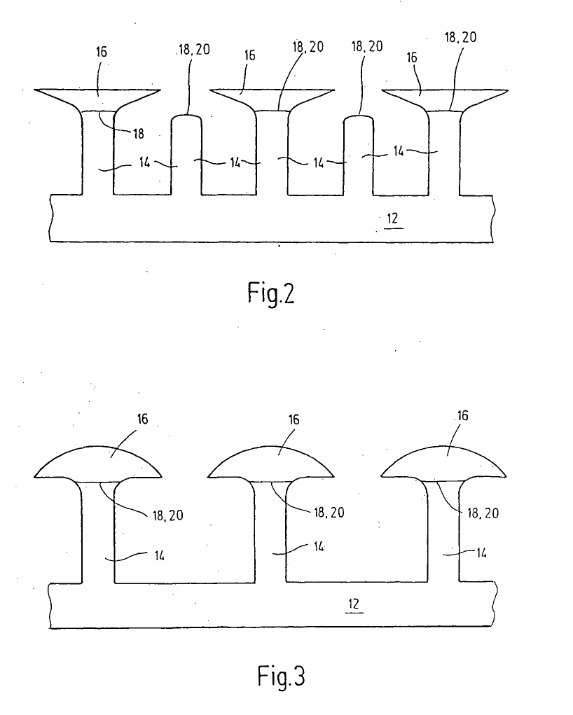

FIGS. 2 and 3 show different embodiments of the touch fastener element which can be produced, in a side view.

The method according to the invention is detailed below using the production apparatus as shown in FIG. 1. The method according to the invention is used to produce a touch fastener element which is designated as a whole as 10 and in which a belt-like backing part 12 is connected to a plurality of projecting stem parts 14 with individual head parts 16 such that at least for some of these stem parts 14 their free ends 18 come into contiguous or embedded contact with the contact side 20 of the respectively assignable head part 16. When using the method according to the invention it is provided that in the actual process of connecting the stem parts 14 to the assignable head parts 16 the latter are still at least in the partially liquid or partially plasticized state and the head parts 16 are completely cured only after the connection. The free ends 18 of the stem parts 14 therefore touch the still at least partially liquid contact sides 20 of the head parts 16 or preferably embed in the material of the head part in order in this way to be able to ensure the connection in the subsequently cured state of the head part 16.

For molding the individual head parts 16 there is a molding tool designated as a whole as 22, with a plurality of individual mold recesses 24 which correspond to the respective head geometry in terms of their configuration. The mold recesses 24 are a component of a molding belt 26 which revolves in the manner of a transport belt, the mold recesses 24 of the upper strand being filled with plastic material and the lower strand guiding essentially the empty mold recesses 24. The mold recesses 24 are in turn repeatedly present in a regular or irregular distribution in the transverse and longitudinal direction of the molding belt 24.

Furthermore there is a supply device designated as a whole as 28 for the already finished backing part 12 with the stem parts 14 whose free ends 18 can be inserted into the mold recesses 24 by means of the supply device 28. For this purpose, the supply device 28 has a type of storage roll 30 from which the stem part-fastener material can be unwound. By way of corresponding deflection rolls 32 the belt material can be supplied to the molding tool 22 and the complete touch fastener product can be taken up on the end onto a transport roll designated as 34 for further transport. For the sake of simpler depiction, individual transport and guide devices have been omitted, likewise the heating and cooling devices for the production apparatus are not shown. The transport direction of the molding tool 22 and the supply device 28 is, however, indicated with an arrow 36.

As FIG. 1 further shows, the mold recesses 24 are open to the outside, that is, they are freely accessible from there, for filling the mold recesses 24 of the molding tool 22 a filling device 38 being used which, without being specified in detail, can be a conventional extruder application device, but preferably constitutes a droplet application apparatus which does not completely fill the mold recesses 24 as far as the free edge with plastic material without the mold recesses 24 overflowing. The filling device 38 can, however, also be made as a doctor device for the plastic material, excess plastic material being removable from the top of the belt by means of the so-called doctor blade device (not shown).

To produce the fixed connection between the stem parts 14 and the head parts 16, in turn a curing device 40 which is not detailed is used which is located preferably at the end of the connecting process, specifically a short distance in front of the point before, viewed in the direction of the arrow 36, the finished touch fastener element removed from the molding tool 22 is carried away in the direction of the transport roll 34. Depending on the respective plastic material used, the curing device 40 can be a conventional heat source, but also an UV emitter and the like. If acrylate material is used for the head parts 16, the curing device 40 is preferably a UV emission source.

Touch fastener elements, produced according to the illustrated method using the described apparatus, are shown enlarged in FIGS. 2 and 3, the head parts 16 as shown in FIG. 2 being made essentially flat toward their free end side; this allows them to be made very narrow-lipped or thin-lipped relative to their surrounding edge, in contrast to the fastener solution as shown in FIG. 3, in which the top of the illustrated head part 16 is convexly curved so that this head part 16 toward the enclosing edge 42 extends with a thicker wall than the above described solution as shown in FIG. 2. It is common to both solutions that the head part 16 consists of acrylate material, while the stem part consists preferably of a thermoplastic material, in particular of polyamide, polypropylene or polyethylene. Other material combinations are possible here.

It is surprising to one with average skill in the art in the field of fastener technology that for mushroom-head fastener systems he can connect any head parts 16 to any stem part material 14 in order in this way to be able to offer functional touch fasteners in a wide range of applications. As FIG. 2 in particular shows, not all stem parts 14 need be provided with a head part 16 and in special applications it would also be possible to provide two and more stem parts 14 with only one head part 16 on the end side (not shown). Furthermore it would be possible, depending on the formation of the mold recesses 24, to devise fastener systems which, for example, combine with one another the head geometries of the fastener elements from FIGS. 2 and 3 according to predefinable patterns. Otherwise it has been shown that with the method according to the invention very smooth and hard head parts 16 can be obtained; this protects the fastener as a whole and leads to very long-lived touch fastener element systems.

Depending on the depth of the mold recesses 24 of the molding tool 22 which are used, different lengths for the stem parts 14 can also optionally be implemented so that then the head parts 16 end at different level heights relative to the belt-like backing part 12. The backing part 12 itself can also consist of a multiextrusion layer arrangement or can have be film-like and elastically stretchable. The indicated head parts 16 viewed from overhead can form spherical shell bodies which are smooth to the outside; but implementations in polygonal form, in particular in a hexagonal shape, are also possible. By using acrylate material for the head parts 16 they also form a type of edge protection toward their surrounding edge 42; this in turn benefits the service life of the overall fastener.

1. A method for the production of an adhesive closure device (10), preferably consisting of at least one plastic material, in which the backing part (12) with a plurality of projecting stem parts (14) is connected to individual head parts (16) such that at least for some of the indicated stem parts (14) their free ends (18) come into contiguous or embedded contact with the contact side (20) of the respectively assignable head part (16).

2. The method according to claim 1, characterized in that in the process of connecting the stem parts (14) and the assignable head parts (16) the latter are still at least in the partially liquid or partially plasticized state and the head parts (16) are completely cured only after the connection.

3. An apparatus for carrying out the method according to claim 1, characterized in that for the individual head parts (16) there is a molding tool (22) with a plurality of mold recesses (24) which correspond to the respective head geometry, and with a supply device (28) for the already finished backing part (12) with the stem parts (14), whose free ends (18) can be inserted into the mold recesses (24) by means of the supply device (28).

4. The apparatus according to claim 3, characterized in that the molding tool (22) is formed from a revolving molding belt (26) which contains the mold recesses (24) which are freely accessible from the outside.

5. The apparatus according to claim 3, characterized in that there is a filling device (38) for filling the mold recesses (24) of the molding tool (22) and that there is a curing device (40) for manifestation of stem parts with head parts (14, 16).

6. A touch fastener element, produced according to the method according to claim 1 and by means of an apparatus, characterized in that the stem parts (14) and head parts (16) consist of plastic materials which are different from one another, in particular the stem parts (14) are formed from a thermoplastic and the head parts (16) consist of acrylate material.

7. The touch fastener element according to claim 6, characterized in that the head parts (16) each have a flat-shaped or convexly shaped top of the head and or that the respective enclosing edge (42) of the head part (16) is made preferably narrow-lipped.

8. The touch fastener element according to claim 6, characterized in that on the edge side the respective head part (16) has corners, in particular it is made as a hexagon.
